(19) United States
(12) Patent Application Publication
(10) Pub. No.: US 2013/0112338 A1
(43) Pub. Date: May 9, 2013

(54) METHOD OF MANUFACTURING MULTILAYER CERAMIC CAPACITOR

(71) Applicants: Young Ho Kim, Suwon (KR); Jong Han Kim, Suwon (KR); Hyun Chul Jeong, Suwon (KR)

(72) Inventors: Young Ho Kim, Suwon (KR); Jong Han Kim, Suwon (KR); Hyun Chul Jeong, Suwon (KR)

(73) Assignee: SAMSUNG ELECTRO-MECHANICS CO., LTD.

(21) Appl. No.: 13/610,343

(22) Filed: Sep. 11, 2012

(30) Foreign Application Priority Data
Nov. 4, 2011 (KR) 10-2011-0114348

(51) Int. Cl. H01G 13/00

(52) U.S. Cl. 156/89.12; 156/250

(57) ABSTRACT

There is provided a method of manufacturing a multilayer ceramic capacitor including: laminating ceramic green sheets having internal electrodes printed thereon to form a ceramic laminated body; cutting the ceramic laminated body; applying slurry including a ceramic powder to the ceramic laminated body; and drying the slurry applied to the ceramic laminated body. According to an embodiment of the present invention, cracks generated in a manufacturing process of the multilayer ceramic capacitor may be removed, such that the multilayer ceramic capacitor may have excellent reliability.

### CROSS-REFERENCE TO RELATED APPLICATIONS

This application claims the priority of Korean Patent Application No. 10-2011-0114348 filed on Nov. 4, 2011, in the Korean Intellectual Property Office, the disclosure of which is incorporated herein by reference.

### BACKGROUND OF THE INVENTION

1. Field of the Invention

The present invention relates to a method of manufacturing a multilayer ceramic capacitor capable of removing cracks generated in a manufacturing process.

2. Description of the Related Art

A multilayer ceramic capacitor is formed by laminating a plurality of ceramic green sheets having internal electrodes formed thereon and sintering a laminated body formed through the laminating process. However, at the time of the sintering of the laminated body, excessive stress may be generated due to differences in a sintering shrinkage initiation temperature and a contraction rate between an internal electrode material and a green sheet material. Therefore, defects such as a problem in the functioning of the multilayer ceramic capacitor or a structural fault may easily be generated.

Further, in accordance with the trend for small-sized, multi-functional electronic devices, a small-sized, high-capacity multilayer ceramic capacitor has been required.

In accordance with the trend for small-sized multilayer ceramic capacitors, internal defects such as cracks may be generated at an interface between a dielectric layer and an internal electrode layer even in the case of a relatively small change in internal stress caused due to a process such as cutting or sintering a ceramic green sheet.

In the case in which internal defects such as cracks are generated at the interface between the dielectric layer and the internal electrode layer, desired characteristics such as secure capacitance may not be obtained and the reliability of a multilayer ceramic electronic component such as a multilayer ceramic capacitor may be deteriorated.

### SUMMARY OF THE INVENTION

An aspect of the present invention provides a multilayer ceramic capacitor having excellent reliability by suppressing crack generation therein.

According to an aspect of the present invention, there is provided a method of manufacturing a multilayer ceramic capacitor, the method including: laminating ceramic green sheets having internal electrodes printed thereon to form a ceramic laminated body; cutting the ceramic laminated body; applying slurry including a ceramic powder to the ceramic laminated body; and drying the slurry applied to the ceramic laminated body.

After the drying of the slurry applied to the ceramic laminated body, the method may further include applying a conductive paste for external electrodes to end portions of the ceramic laminated body to be electrically connected to the internal electrodes; and sintering the ceramic laminated body to form external electrodes.

The ceramic powder of the slurry may be the same material as a ceramic material of the ceramic green sheets.

The slurry may have a solubility parameter (SP) value of 7.1 to 8.0 (cal/cm³)^{0.5}.

The ceramic powder of the slurry may have a solids content of 3 to 20%.

A ratio of viscosity of the slurry at 10 rpm to viscosity of the slurry at 100 rpm may be 1.6 to 3.0.

The applying of the slurry to the ceramic laminated body may be performed by dipping the ceramic laminated body into the slurry.

The applying of the slurry to the ceramic laminated body may be performed by a spraying method.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a process diagram illustrating a method of manufacturing a multilayer ceramic capacitor according to an embodiment of the present invention;

FIG. 2 is a process diagram illustrating a method of manufacturing a multilayer ceramic capacitor according to another embodiment of the present invention; and

FIG. 3 is a perspective view of a multilayer ceramic capacitor manufactured according to an embodiment of the present invention.

### DETAILED DESCRIPTION OF THE EMBODIMENTS

Embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

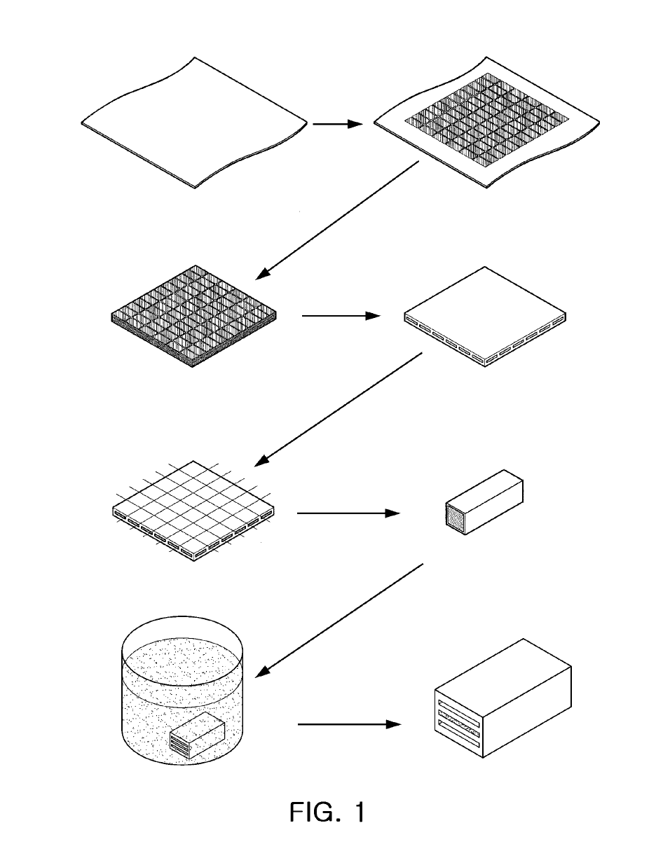

Hereinafter, a multilayer ceramic capacitor according to an embodiment of the present invention will be described with reference to FIGS. 1 through 3.

FIG. 1 is a process diagram illustrating a method of manufacturing a multilayer ceramic capacitor according to an embodiment of the present invention.

According to the embodiment of the present invention, a first ceramic green sheet having a first internal electrode formed thereon and a second ceramic green sheet having a second internal electrode formed thereon may be prepared. The first and second ceramic green sheets are alternately laminated to thereby form a ceramic laminated body.

The first and second internal electrodes may be printed on the first and second ceramic green sheets by applying a conductive paste containing metal powder particles to the first and second ceramic green sheets, respectively.

The ceramic laminated body formed by alternately laminating the first and second ceramic green sheets may be thermo-compressed and then be further cut.

Ceramic slurry including a ceramic power may be applied to the ceramic laminated body, and the slurry applied to the ceramic laminated body may be dried.

The application of the slurry to the ceramic laminated body may be performed by dipping the ceramic laminated body into the slurry.

In a process of cutting the ceramic laminated body, the internal electrode and the ceramic green sheet may be separated by a cutting action of a blade, or at the time of sintering the ceramic laminated body, cracks may be generated due to changes in internal stress caused by differences in a contraction rate between an internal electrode material and a green sheet material.

According to the embodiment of the present invention, a slurry including the same ceramic powder as a ceramic material forming the ceramic green sheet may be applied to the location in which the internal electrode and the ceramic green sheet of the ceramic laminated body are separated or the cracks are generated due to the changes in internal stress and be then dried, such that the cracks may be filled with the slurry.

Next, a conductive paste for external electrodes may be applied to end portions of the ceramic laminated body to be electrically connected to the first and second internal electrodes. After the ceramic laminated body is sintered, external electrodes may be formed such that a multilayer ceramic capacitor may be manufactured.

Therefore, according to the embodiment of the present invention, the generation of cracks in the multilayer ceramic capacitor may be prevented by applying the slurry to the ceramic laminated body. Therefore, a multilayer ceramic capacitor having excellent reliability may be manufactured.

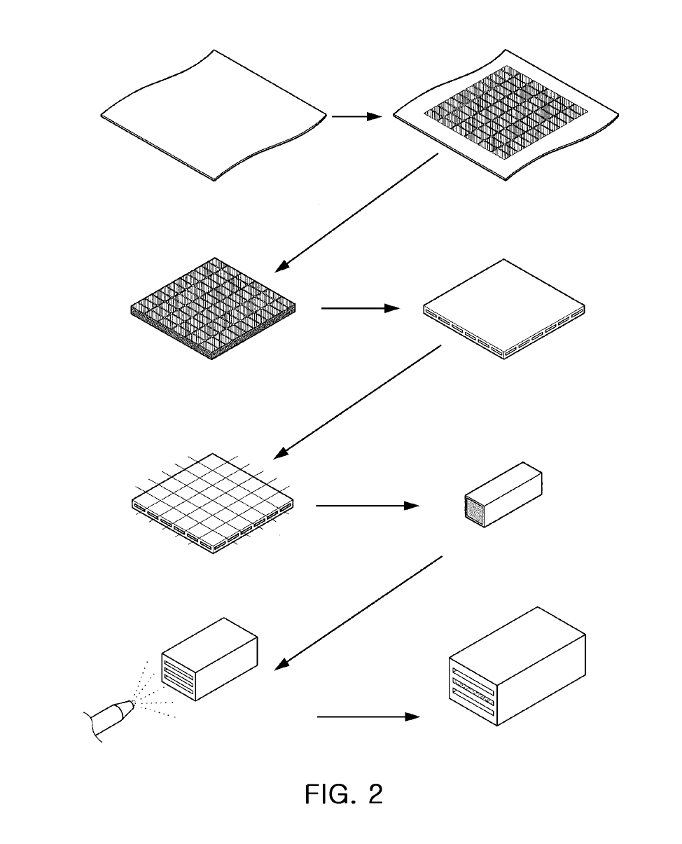

FIG. 2 is a process diagram illustrating a method of manufacturing a multilayer ceramic capacitor according to another embodiment of the present invention.

Referring to FIG. 2, a process of applying slurry to the ceramic laminated body may be performed by spraying the slurry including the ceramic powder onto the ceramic laminated body to disperse the slurry. The slurry may be dispersed into locations in which the cracks are generated to thereby be applied thereto, such that the generation of the cracks may be suppressed.

Samples 1 through 28 of 28 of sintering aids in which solubility parameter (SP) of the slurry, a solids content of the ceramic powder, and a ratio of viscosity of the slurry at 10 rpm to viscosity of the slurry at 100 rpm (hereinafter, a viscosity ratio) were variously changed were sampled. Electrode connectivity and crack removal according to a SP value of the slurry, a solids content of the ceramic powder, and a viscosity ratio thereof are shown in Table 1.

TABLE 1

| | | Solids | | | Viscosity | | |
|---|---|---|---|---|---|---|---|
| | SP value | Content | Viscosity | Viscosity | Ratio | Electrode | Crack |
| | (cal/cm³)^{0.5} | (%) | (10 rpm) | (100 rpm) | (10/100) | Connectivity | Removal |
| 1 | 9.0~9.9 | 3 | 30 | 10 | 3.00 | ◯ | ◯ |
| 2 | | 5 | 50 | 20 | 2.50 | ◯ | ◯ |
| 3 | | 10 | 100 | 50 | 2.00 | ◯ | ◯ |
| 4 | | 15 | 150 | 90 | 1.67 | ◯ | ◯ |
| 5 | | 20 | 200 | 125 | 1.60 | ◯ | ◯ |
| 6 | | 25 | 250 | 160 | 1.56 | X | X |
| 7 | | 30 | 300 | 200 | 1.50 | X | X |
| 8 | 8.1~9.0 | 3 | 30 | 10 | 3.00 | X | ◯ |
| 9 | | 5 | 50 | 20 | 2.50 | X | ◯ |
| 10 | | 10 | 100 | 50 | 2.00 | X | ◯ |
| 11 | | 15 | 150 | 90 | 1.67 | X | ◯ |
| 12 | | 20 | 200 | 125 | 1.60 | X | ◯ |
| 13 | | 25 | 250 | 160 | 1.56 | X | ◯ |
| 14 | | 30 | 300 | 200 | 1.50 | X | ◯ |
| 15 | 7.1~8.0 | 3 | 30 | 10 | 3.00 | ⊚ | ⊚ |
| 16 | | 5 | 50 | 20 | 2.50 | ⊚ | ⊚ |
| 17 | | 10 | 100 | 50 | 2.00 | ⊚ | ⊚ |
| 18 | | 15 | 150 | 90 | 1.67 | ⊚ | ⊚ |
| 19 | | 20 | 200 | 125 | 1.60 | ⊚ | ⊚ |
| 20 | | 25 | 250 | 160 | 1.56 | ◯ | ⊚ |
| 21 | | 30 | 300 | 200 | 1.50 | ◯ | ⊚ |
| 22 | 5.1~7.0 | 3 | 30 | 20 | 1.50 | X | ⊚ |
| 23 | | 5 | 50 | 30 | 1.67 | X | ⊚ |
| 24 | | 10 | 100 | 80 | 1.25 | X | ◯ |
| 25 | | 15 | 150 | 120 | 1.25 | X | ◯ |
| 26 | | 20 | 200 | 180 | 1.11 | X | ◯ |
| 27 | | 25 | 250 | 230 | 1.09 | X | ◯ |
| 28 | | 30 | 300 | 280 | 1.07 | X | ◯ |

Samples 1 through 7 were slurry having an SP value of 9.0 to 9.9 and manufactured by changing the solids content of the ceramic powder from 3 to 30% and changing the viscosity ratio of the slurry from 1.50 to 3.00.

Samples 8 through 14 were slurry having an SP value of 8.1 to 9.0 and manufactured by changing the solids content of the ceramic powder from 3 to 30% and changing the viscosity ratio of the slurry thereof from 1.50 to 3.00.

Samples 15 through 21 were slurry having an SP value of 7.1 to 8.0 and manufactured by changing the solids content of the ceramic powder from 3 to 30% and changing the viscosity ratio of the slurry from 1.50 to 3.00.

Samples 22 through 28 were slurry having an SP value of 5.1 to 7.0 and manufactured by changing the solids content of the ceramic powder from 3 to 30% and changing the viscosity ratio of the slurry from 1.07 to 1.50.

After the ceramic laminated body was cut, the slurry formed as each sample was applied to the cut ceramic laminated body. The application of the slurry to the ceramic laminated body may be performed by a dipping method or a spraying method. After the slurry applied to the ceramic laminated body was dried, the ceramic laminated body was sintered, and then electrode connectivity and crack removal were evaluated.

The case in which a crack removal rate was 75% or less was indicated as “bad (x)”, the case in which the crack removal rate was 75% to 85% was indicated as “satisfactory (∘)”, and the case in which the crack removal rate was 85% or more was indicated as “excellent (⊚)”.

Referring to Table 1, when the SP value of the slurry is 5.1 to 9.0, the solids content of the ceramic power is 3% to 20%, or the viscosity ratio of the slurry is 1.6 to 3.0, 75% or more of cracks may be removed.

Most preferably, when the SP value of the slurry is 7.1 to 8.0, the solids content of the ceramic power is 3 to 20%, and the viscosity ratio of the slurry is 1.6 to 3.0, both excellent electrode connectivity and a high crack removal rate may be realized.

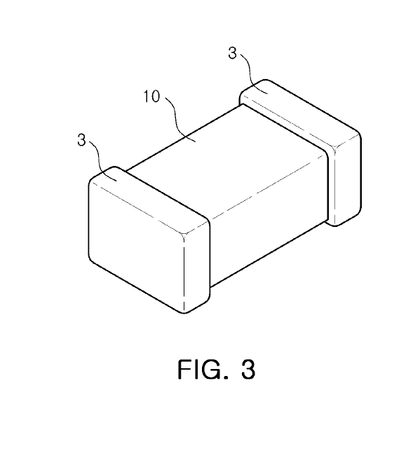

FIG. 3 is a perspective view of a multilayer ceramic capacitor manufactured according to an embodiment of the present invention.

According to the embodiment of the present invention, cracks generated in a process of manufacturing a multilayer ceramic capacitor may be filled with a slurry by applying the slurry to a ceramic laminated body, such that a crack generation rate may be reduced. Therefore, the reliability of the multilayer ceramic capacitor may be improved.

As set forth above, according to embodiments of the present invention, cracks generated in a process of manufacturing a multilayer ceramic capacitor may be removed, whereby the multilayer ceramic capacitor having excellent reliability may be provided.

While the present invention has been shown and described in connection with the embodiments, it will be apparent to those skilled in the art that modifications and variations can be made without departing from the spirit and scope of the invention as defined by the appended claims.

What is claimed is:

1. A method of manufacturing a multilayer ceramic capacitor, the method comprising:
laminating ceramic green sheets having internal electrodes printed thereon to form a ceramic laminated body;
cutting the ceramic laminated body;
applying slurry including a ceramic powder to the ceramic laminated body; and
drying the slurry applied to the ceramic laminated body.

2. The method of claim 1, wherein the ceramic powder of the slurry is the same material as a ceramic material of the ceramic green sheets.

3. The method of claim 1, wherein the slurry has a solubility parameter (SP) value of 7.1 to 8.0 (cal/cm³)^{0.5}.

4. The method of claim 1, wherein the ceramic powder of the slurry has a solids content of 3 to 20%.

5. The method of claim 1, wherein a ratio of viscosity of the slurry at 10 rpm to viscosity of the slurry at 100 rpm is 1.6 to 3.0.

6. The method of claim 1, wherein the applying of the slurry to the ceramic laminated body is performed by dipping the ceramic laminated body into the slurry.

7. The method of claim 1, wherein the applying of the slurry to the ceramic laminated body is performed by a spraying method.

8. The method of claim 1, further comprising, after the drying of the slurry applied to the ceramic laminated body, applying a conductive paste for external electrodes to end portions of the ceramic laminated body to be electrically connected to the internal electrodes; and
sintering the ceramic laminated body to form external electrodes.
